(19) United States
(12) Patent Application Publication
(10) Pub. No.: US 2026/0030763 A1
(43) Pub. Date: Jan. 29, 2026

(54) MOTION ANALYSIS SYSTEM, MOTION ANALYSIS METHOD, AND INFORMATION STORAGE MEDIUM

(71) Applicant: Rakuten Group, Inc., Tokyo (JP)

(72) Inventors: Masahiro KUWAHARA, Tokyo (JP); Nahoko SAKAMOTO, Tokyo (JP); Keisuke SADAHIRO, Tokyo (JP); Yuki YAMAGUCHI, Tokyo (JP)

(73) Assignee: Rakuten Group, Inc., Tokyo (JP)

(21) Appl. No.: 19/274,994

(22) Filed: Jul. 21, 2025

(30) Foreign Application Priority Data
Jul. 24, 2024 (JP) 2024-118755

(51) Int. Cl. G06T 7/20; G06T 7/70

(52) U.S. Cl. CPC G06T 7/20; G06T 7/70; G06T 2207/10016; G06T 2207/30196; G06T 2207/30221

(57) ABSTRACT

An evaluation result information transmission module displays an identified display image, which is a frame image in which a position of an object corresponding to any one of a plurality of check items associated with a scene is displayed to be identified. The evaluation result information transmission module changes, in response to reception of a check item change request, the displayed identified display image from the frame image in which the position of the object corresponding to the one of the check items is displayed to be identified to the frame image in which the position of an object corresponding to a check item different from the one of the check items is displayed to be identified.

### CROSS-REFERENCE TO RELATED APPLICATIONS

The present application claims priority from Japanese application JP2024-118755 filed on Jul. 24, 2024, the content of which is hereby incorporated by reference into this application.

### BACKGROUND OF THE INVENTION

### 1. Field of the Invention

The present invention relates to a motion analysis system, a motion analysis method, and a program.

### 2. Description of the Related Art

In Japanese Patent Application Laid-open No. 2022-104413, there is described a golf swing analysis system that displays an image showing a moving direction of a clubhead at impact, an orientation of a face of a club at impact, a launch direction of a ball, and a curve direction of the launched ball, for example.

### SUMMARY OF THE INVENTION

A golf swing motion includes a plurality of scenes such as address, takeaway, top of swing, and impact. For each scene, there may be a plurality of check items (e.g., forward tilt angle, right knee angle, and clubhead position). However, the technology as described in Japanese Patent Application Laid-open No. 2022-104413 cannot display how each of the plurality of check items in a scene is in an easy-to-understand manner. It is convenient when the display in an easy-to-understand manner can be performed for other general motions as well as the golf swing motion.

The present invention has been made in view of the above-mentioned problems, and it is one object of the present invention to provide a motion analysis system, a motion analysis method, and an information storage medium that enable display of how each of a plurality of check items in a scene included in a motion is in an easy-to-understand manner.

(1) According to at least one embodiment of the present invention, there is provided a motion analysis system including: frame image extraction means for extracting a frame image representing each of a plurality of scenes from a video obtained by capturing a person who is making a given motion; scene determination means for determining any one of the plurality of scenes; position identification means for identifying, in the frame image representing the determined one of the plurality of scenes, a position at which each of a plurality of objects respectively corresponding to a plurality of check items associated with the determined one of the plurality of scenes is shown, the position of the each of the plurality of objects being determined by a posture of the person in the determined one of the plurality of scenes; display control means for displaying an identified display image, the identified display image being the frame image in which the position of one of the plurality of objects corresponding to any one of a plurality of check items associated with the determined one of the plurality of scenes is displayed to be identified; and display changing means for changing, in response to reception of a check item change request, the displayed identified display image from the frame image in which the position of the one of the plurality of objects corresponding to the one of the plurality of check items is displayed to be identified to the frame image in which the position of one of the plurality of objects corresponding to a check item different from the one of the plurality of check items is displayed to be identified.

(2) In the motion analysis system according to Item (1), the display changing means may be configured to change, in response to reception of a scene change request, the displayed identified display image from the frame image representing any one of the plurality of scenes, in which the position of one of the plurality of objects corresponding to any one of the plurality of check items associated with the one of the plurality of scenes is displayed to be identified, to the frame image representing one of the plurality of scenes different from the one of the plurality of scenes, in which the position of the one of the plurality of objects is displayed to be identified.

(3) In the motion analysis system according to Item (1) or (2), at least one of the plurality of objects may be a body part included in the person.

(4) The motion analysis system according to Item (3) may further include skeleton identification means for identifying a position at which a skeleton of the person captured in the frame image is shown in the frame image, and at least one of the plurality of objects may be a portion of the skeleton.

(5) In the motion analysis system according to Item (1) or (2), at least one of the plurality of objects may be at least a portion of a golf club used by the person.

(6) According to at least one embodiment of the present invention, there is provided a motion analysis method including: determining any one of a plurality of scenes; acquiring a frame image representing the determined one of the plurality of scenes, the frame image being one of frame images respectively representing the plurality of scenes and extracted from a video obtained by capturing a person who is making a given motion; identifying, in the acquired frame image, a position at which each of a plurality of objects which have the positions determined by a posture of the person in the determined one of the plurality of scenes and which respectively correspond to a plurality of check items associated with the determined one of the plurality of scenes is shown; displaying an identified display image, the identified display image being the frame image in which the position of one of the plurality of objects corresponding to any one of a plurality of check items associated with the determined one of the plurality of scenes is displayed to be identified; and changing, in response to reception of a check item change request, the displayed identified display image from the frame image in which the position of the one of the plurality of objects corresponding to the one of the plurality of check items is displayed to be identified to the frame image in which the position of one of the plurality of objects corresponding to a check item different from the one of the plurality of check items is displayed to be identified.

(7) According to at least one embodiment of the present invention, there is provided an information storage medium storing a program that causes a computer to execute: determining any one of a plurality of scenes; acquiring a frame image representing the determined one of the plurality of scenes, the frame image being one of frame images respectively representing the plurality of scenes and extracted by a frame image extraction module from a video obtained by capturing a person who is making a given motion; identifying, in the acquired frame image, a position at which each of a plurality of objects which have the positions determined by a posture of the person in the determined one of the plurality of scenes and which respectively correspond to a plurality of check items associated with the determined one of the plurality of scenes is shown; displaying an identified display image, the identified display image being the frame image in which the position of one of the plurality of objects corresponding to any one of a plurality of check items associated with the determined one of the plurality of scenes is displayed to be identified; and changing, in response to reception of a check item change request, the displayed identified display image from the frame image in which the position of the one of the plurality of objects corresponding to the one of the plurality of check items is displayed to be identified to the frame image in which the position of one of the plurality of objects corresponding to a check item different from the one of the plurality of check items is displayed to be identified.

### BRIEF DESCRIPTION OF THE DRAWINGS

FIG. 1 is a diagram for illustrating a configuration example of a motion analysis system according to at least one embodiment of the present invention.

FIG. 2 is a view for illustrating an example of an analysis result screen.

FIG. 3 is a view for illustrating an example of the analysis result screen.

FIG. 4 is a view for illustrating an example of the analysis result screen.

FIG. 5 is a view for illustrating an example of the analysis result screen.

FIG. 6 is a view for illustrating an example of the analysis result screen.

FIG. 7 is a functional block diagram for illustrating an example of functions of a server in the at least one embodiment of the present invention.

FIG. 8 is a table for showing an example of evaluation management data.

FIG. 9 is a diagram for illustrating an example of a skeleton.

FIG. 10 is a flowchart for illustrating an example of a flow of processing performed in a server in the at least one embodiment of the present invention.

FIG. 11 is a flowchart for illustrating an example of a flow of processing performed in the server in the at least one embodiment of the present invention.

FIG. 12 is a flowchart of for illustrating example of a flow of processing performed in the server in the at least one embodiment of the present invention.

### DETAILED DESCRIPTION OF THE INVENTION

Description is given below in detail of at least one embodiment of the present invention with reference to the drawings.

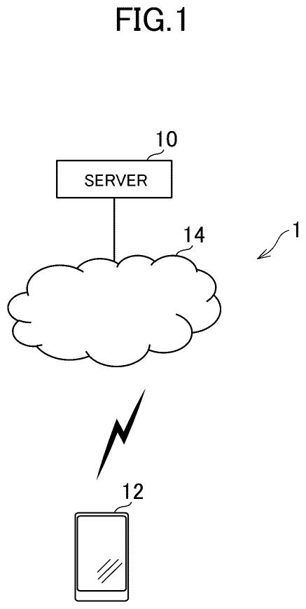

FIG. 1 is a diagram for illustrating a configuration example of a motion analysis system 1 according to the at least one embodiment of the present invention.

The motion analysis system 1 according to the at least one embodiment includes a server 10 and a terminal 12. The server 10 and the terminal 12 are connected to a computer network 14 such as the Internet and can communicate to and from each other via the computer network 14.

The server 10 is a general-purpose computer including a processor, a storage unit (e.g., a memory and a hard disk drive (HDD)), and a communication unit (e.g., a communication interface), for example.

The terminal 12 is a computer such as a mobile phone (including a smartphone) and a portable information terminal (including a tablet computer). The terminal 12 includes a processor, a storage unit (e.g., a memory and a solid state drive (SSD)), a communication unit (e.g., a communication interface), a sensor unit (e.g., a camera, a touch panel, a GPS module, an acceleration sensor, and a motion sensor), for example.

In the at least one embodiment, a user operating the terminal 12, for example, captures a video of a player who is making a golf swing by using a camera included in the terminal 12 on a golf course or in a driving range. The video of the player who is making the swing is thus generated.

In the at least one embodiment, prior to capturing of the swing, the position and the tilt of the terminal 12 are adjusted in such a manner that a position of the player with respect to the camera position falls within a predetermined allowable range, and an orientation of the player with respect to a capturing direction falls within a predetermined allowable range. After the adjustment of the terminal 12, when the user performs a predetermined operation, capturing of the player by the camera is performed, and a video of the player who is making the swing is generated in the at least one embodiment. In the at least one embodiment, it is assumed that the number of vertical and horizontal pixels of each frame image is the same in all frame images included in the generated video.

The thus generated video is uploaded from the terminal 12 to the server 10. The video thus uploaded is hereinafter referred to as “captured video.”

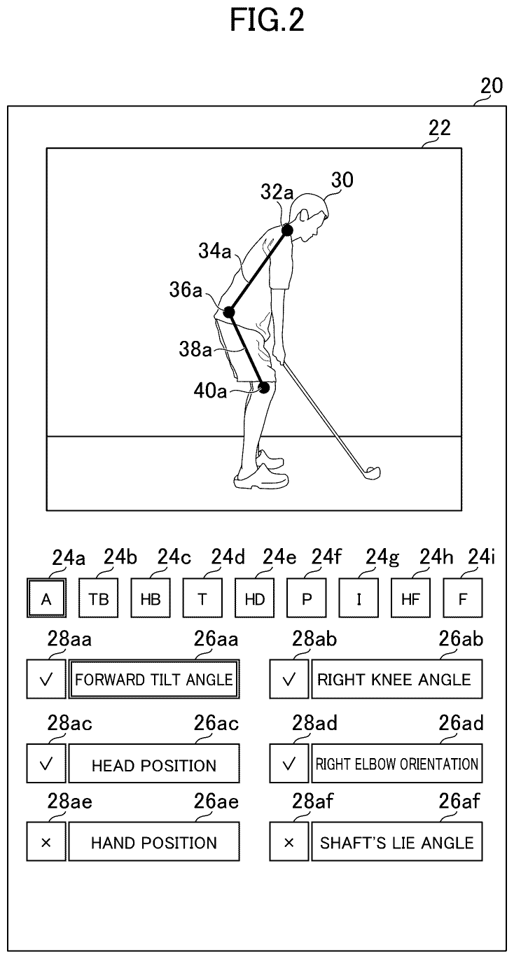

In the server 10, motion analysis of a person captured in the captured video (the player who is making the swing in this example) is executed. An analysis result screen 20 (see FIG. 2 to FIG. 6) showing the result of this motion analysis is transmitted from the server 10 to the terminal 12. The analysis result screen 20 is then displayed on a touch panel (display) of the terminal 12.

As illustrated in FIG. 2, an identified display image 22, scene icons 24, check item icons 26, and evaluation icons 28 are arranged on the analysis result screen 20.

In the at least one embodiment, a plurality of scenes (phases) are predefined, for example. In this example, it is assumed that nine scenes (address, takeaway, halfway back, top of swing, halfway down, pre-impact, impact, halfway follow, and finish) are predefined, for example. The scene icons 24 (24a to 24i) corresponding to the respective scenes are arranged on the analysis result screen 20.

Further, at least one check item is associated with each of the scenes. For example, six check items (forward tilt angle, right knee angle, head position, right elbow orientation, hand position, and shaft's lie angle) are associated with the scene of address. Further, five check items (forward tilt angle, elbow and hand positions, right forearm angle, right knee angle, and clubhead position) are associated with the scene of top of swing, for example. The number of check items associated with each scene may be different between scenes in this manner.

In the at least one embodiment, any one of the plurality of scenes is determined as a scene of interest. For each of at least one check item associated with the scene of interest, the check item icon 26 corresponding thereto is arranged on the analysis result screen 20.

FIG. 2 shows the analysis result screen 20 in a situation in which the scene of interest is the scene of address. In this situation, the scene icon 24 corresponding to the address (the scene icon 24a) is displayed to be identified in a different form (e.g., in a different color or shape) from the other scene icons 24.

In addition, in this situation, the check item icons 26 (26aa to 26af) respectively corresponding to the six check items associated with the scene of address are arranged on the analysis result screen 20.

On the left side of each check item icon 26, the evaluation icon 28 is arranged which indicates whether the check item corresponding to that check item icon 26 satisfies an evaluation criterion.

In the example of FIG. 2, evaluation icons 28aa to 28af respectively corresponding to the check item icons 26aa to 26af are arranged on the analysis result screen 20. On each of the evaluation icon 28aa, the evaluation icon 28ab, the evaluation icon 28ac, and the evaluation icon 28ad, a check mark indicating that the evaluation criterion is satisfied is shown. On each of the evaluation icon 28ae and the evaluation icon 28af, a cross mark indicating that the evaluation criterion is not satisfied is shown. That is, in the example of FIG. 2, it is shown that in the scene of address, the evaluation criteria are satisfied for a forward tilt angle, a right knee angle, a head position, and a right elbow orientation, but the evaluation criteria are not satisfied for a hand position and a shaft's lie angle.

In the at least one embodiment, any one of at least one check item associated with the scene of interest is determined as a check item of interest. The identified display image 22 generated based on the combination of the scene of interest and the check item of interest is then arranged on the analysis result screen 20.

FIG. 2 shows the analysis result screen 20 in a case in which the scene of interest is the scene of address and the check item of interest is a forward tilt angle. In this case, as illustrated in FIG. 2, the identified display image 22 is arranged on the analysis result screen 20, in which a point representing the position of a neck 32a of a player 30, a solid line segment representing the position of a back 34a, a point representing the position of a hip 36a, a solid line segment representing the position of a right thigh 38a, and a point representing the position of a right knee 40a in the scene of address are displayed in a superimposed manner on a frame image representing the scene of address.

Further, in the at least one embodiment, by the user performing an operation to select a scene, the selected scene is determined as the scene of interest. That is, the scene of interest is changed to the selected scene. Then, any one of at least one check item associated with the changed scene of interest is determined as the check item of interest. In this case, for example, a predetermined check item may be determined as the check item of interest.

The check item icons 26 arranged on the analysis result screen 20 are then updated to the icon corresponding to the at least one check item associated with the changed scene of interest, and the identified display image 22 arranged on the analysis result screen 20 is updated to an image generated based on the combination of the changed scene of interest and the changed check item of interest.

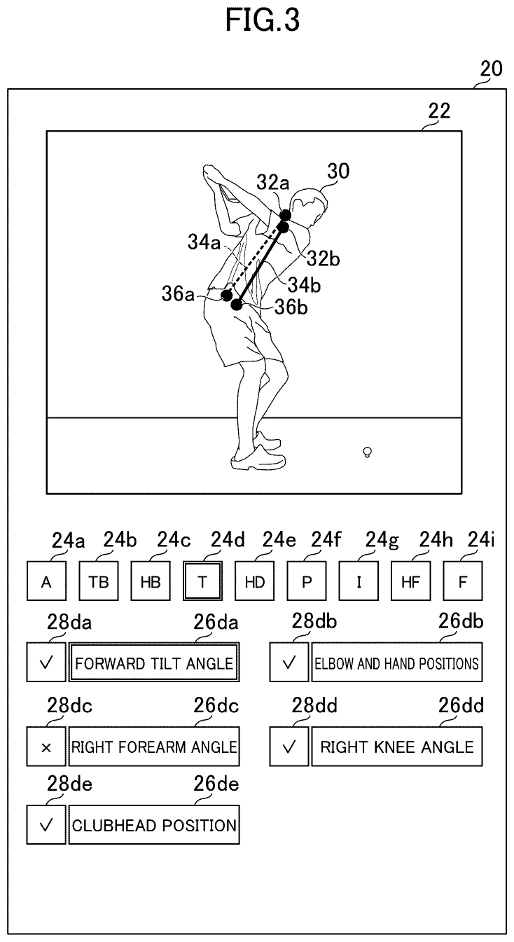

For example, in a situation in which the analysis result screen 20 illustrated in FIG. 2 displayed, when a predetermined operation (e.g., a tap operation) is performed for the scene icon 24 corresponding to the scene of top of swing (the scene icon 24d), the analysis result screen 20 being displayed is changed to the analysis result screen 20 illustrated in FIG. 3.

FIG. 3 to FIG. 6 show the analysis result screens 20 in a case in which the scene of interest is the scene of top of swing. In the example of FIG. 3 to FIG. 6, the check item icons 26 (26da to 26de) respectively corresponding to the five check items associated with the scene of top of swing are arranged on the analysis result screen 20.

Further, in the at least one embodiment, by the user performing an operation to select a check item, the selected check item is determined as the check item of interest. That is, the check item of interest is changed to the selected check item. The identified display image 22 arranged on the analysis result screen 20 is then updated to an image generated based on the combination of the current scene of interest and the changed check item of interest.

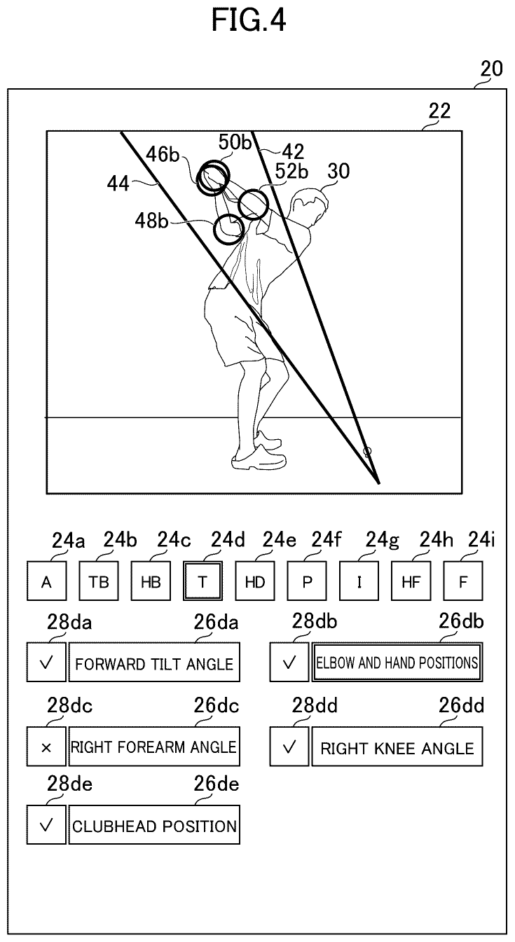

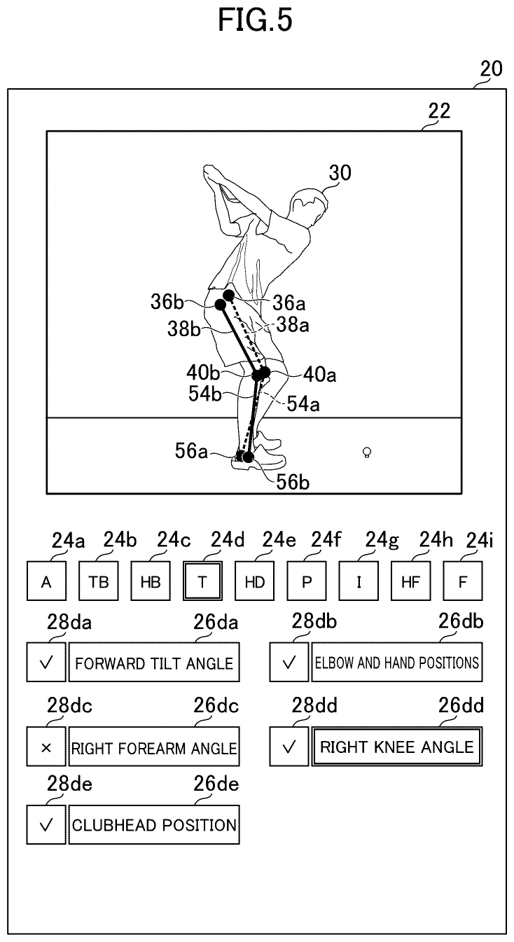

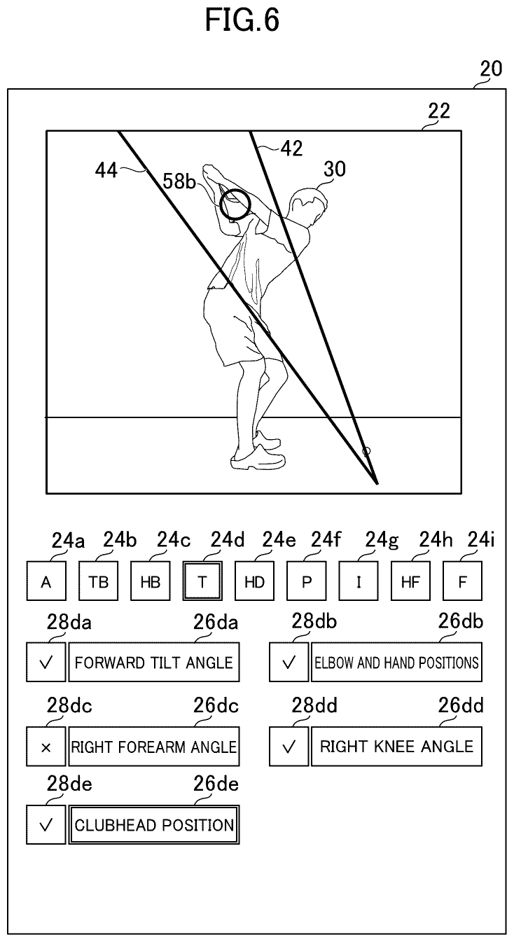

For example, in a situation in which the analysis result screen 20 illustrated in FIG. 3 is displayed, when a predetermined operation (e.g., a tap operation) is performed for the check item icon 26 corresponding to elbow and hand positions (the check item icon 26db), the analysis result screen 20 being displayed is changed to the analysis result screen 20 illustrated in FIG. 4. Further, when the predetermined operation (e.g., the tap operation) is performed for the check item icon 26 corresponding to a right knee angle (the check item icon 26dd), the analysis result screen 20 being displayed is changed to the analysis result screen 20 illustrated in FIG. 5. Further, when the predetermined operation (e.g., the tap operation) is performed for the check item icon 26 corresponding to a clubhead position (the check item icon 26de), the analysis result screen 20 being displayed is changed to the analysis result screen 20 illustrated in FIG. 6.

In the example of FIG. 3 to FIG. 6, the evaluation icons 28 (28da to 28de) respectively corresponding to the check item icons 26 (26da to 26de) are also arranged on the analysis result screen 20. On each of the evaluation icon 28da, the evaluation icon 28db, the evaluation icon 28dd, and the evaluation icon 28de, a check mark indicating that the evaluation criterion is satisfied is arranged. On the evaluation icon 28dc, a cross mark indicating that the evaluation criterion is not satisfied is arranged. That is, in the example of FIG. 3 to FIG. 6, it is shown that in the scene of top of swing, the evaluation criteria are satisfied for a forward tilt angle, elbow and hand positions, a right knee angle, and a clubhead position, but the evaluation criterion is not satisfied for a right forearm angle.

FIG. 3 shows the analysis result screen 20 in a case in which the scene of interest is the scene of top of swing and the check item of interest is a forward tilt angle. In the example of FIG. 3, the identified display image 22 in which graphics representing body parts of the player 30 in the scene of address and graphics representing body parts of the player 30 in the scene of top of swing are displayed in a superimposed manner on a frame image representing the scene of top of swing is arranged on the analysis result screen 20. For example, in the identified display image 22 illustrated in FIG. 3, a point representing the position of the neck 32a of the player 30, a broken line segment representing the position of the back 34a, and a point representing the position of the hip 36a in the scene of address are arranged. In addition, a point representing the position of a neck 32b of the player 30, a solid line segment representing the position of a back 34b, and a point representing the position of a hip 36b in the scene of top of swing are arranged in the identified display image 22 illustrated in FIG. 3.

FIG. 4 shows the analysis result screen 20 in a case in which the scene of interest is the scene of top of swing and the check item of interest is elbow and hand positions. In the example of FIG. 4, the identified display image 22 in which a V-zone whose position is identified based on a frame image representing the scene of address and the graphics representing the body parts of the player 30 in the scene of top of swing are displayed in a superimposed manner on the frame image representing the scene of top of swing is arranged on the analysis result screen 20. For example, in the identified display image 22 illustrated in FIG. 4, an upper side 42 and a lower side 44 of the V-zone whose position is identified based on the frame image representing the scene of address are arranged. In addition, in the identified display image 22 illustrated in FIG. 4, a circle representing the position of a right hand 46b of the player 30, a circle representing the position of a right elbow 48b, a circle representing the position of a left hand 50b, and a circle representing the position of a left elbow 52b in the scene of top of swing are arranged.

Here, the V-zone means a region surrounded by the lower side 44 corresponding to the position at which a club shaft is shown in a frame image representing the scene of address and the upper side 42 corresponding to the position of a line connecting the player's neck 32a and a golf ball to each other in the frame image representing the scene of address. The definition of the V-zone is not limited thereto. For example, the upper side 42 of the V-zone may be a line connecting the player's neck 32a and the clubhead to each other in the frame image representing the scene of address.

FIG. 5 shows the analysis result screen 20 in a case in which the scene of interest is the scene of top of swing and the check item of interest is a right knee angle. In the example of FIG. 5, the identified display image 22 in which graphics representing body parts of the player 30 in the scene of address and graphics representing body parts of the player 30 in the scene of top of swing are displayed in a superimposed manner on a frame image representing the scene of top of swing is arranged on the analysis result screen 20. For example, in the identified display image 22 illustrated in FIG. 5, a point representing the position of the hip 36a of the player 30, a broken line segment representing the position of the right thigh 38a, a point representing the position of the right knee 40a, a broken line segment representing a right calf 54a, and a point representing the position of a right ankle 56a in the scene of address are arranged. In addition, a point representing the position of the hip 36b of the player 30, a solid line segment representing the position of a right thigh 38b, a point representing the position of a right knee 40b, a solid line segment representing the position of a right calf 54b, and a point representing the position of a right ankle 56b in the scene of top of swing are arranged in the identified display image 22 illustrated in FIG. 5.

FIG. 6 shows the analysis result screen 20 in a case in which the scene of interest is the scene of top of swing and the check item of interest is a clubhead position. In this case, the identified display image 22 in which the upper side 42 and the lower side 44 of the V-zone whose position is identified based on the frame image representing the scene of address and a circle representing the position of a clubhead 58b in the scene of top of swing are displayed in a superimposed manner on the frame image representing the scene of top of swing is arranged on the analysis result screen 20.

Functions of the server 10 in the at least one embodiment and processing executed in the server 10 in the at least one embodiment are further described below.

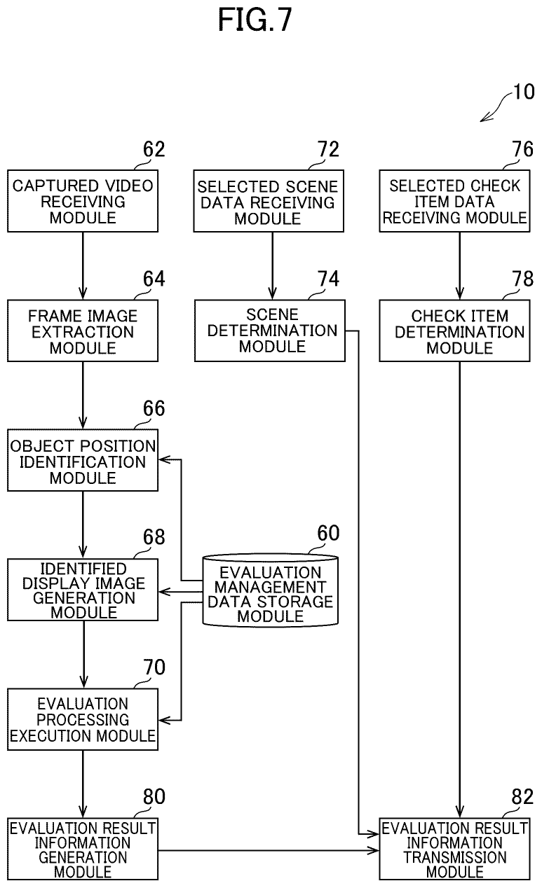

FIG. 7 is a functional block diagram for illustrating an example of functions implemented by the server 10 in the at least one embodiment. It is not required that all the functions illustrated in FIG. 7 be implemented by the server 10 in the at least one embodiment, and a function other than the functions illustrated in FIG. 7 may be implemented.

As illustrated in FIG. 7, the server 10 in the at least one embodiment functionally includes an evaluation management data storage module 60, a captured video receiving module 62, a frame image extraction module 64, an object position identification module 66, an identified display image generation module 68, an evaluation processing execution module 70, a selected scene data receiving module 72, a scene determination module 74, a selected check item data receiving module 76, a check item determination module 78, an evaluation result information generation module 80, and an evaluation result information transmission module 82, for example. The evaluation management data storage module 60 is implemented mainly by the storage module of the server 10. The captured video receiving module 62, the selected scene data receiving module 72, the selected check item data receiving module 76, and the evaluation result information transmission module 82 are implemented mainly by the communication module of the server 10. The frame image extraction module 64, the object position identification module 66, the identified display image generation module 68, the evaluation processing execution module 70, the scene determination module 74, the check item determination module 78, and the evaluation result information generation module 80 are implemented mainly by the processor of the server 10.

Those functions are implemented by execution of programs in the server 10 which is a computer. The programs may be stored in one of various computer-readable information storage media such as a semiconductor memory, and may be loaded from the information storage medium to the server 10. Alternatively, the programs may be downloaded to the server 10 via a data communication line such as the Internet.

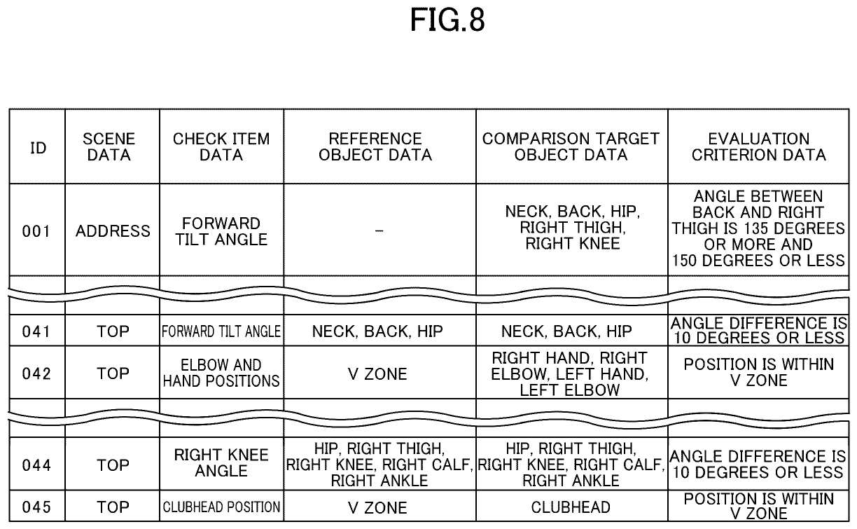

The evaluation management data storage module 60 stores therein evaluation management data shown in FIG. 8 in the at least one embodiment, for example.

As shown in FIG. 8, the evaluation management data includes an ID, scene data, check item data, reference object data, comparison target object data, and evaluation criterion data.

The ID included in the evaluation management data is an identifier of that evaluation management data.

The scene data included in the evaluation management data is data indicating a scene represented by the identified display image 22 generated based on that evaluation management data.

The check item data included in the evaluation management data is data indicating a check item in evaluation processing executed based on that evaluation management data.

The reference object data included in the evaluation management data is data indicating an object that is displayed to be identified in the identified display image 22 generated based on that evaluation management data and whose position is determined by the posture of a person in a predetermined scene such as a first scene (the scene of address in the above-mentioned example).

The comparison target object data included in the evaluation management data is data indicating an object that is displayed to be identified in the identified display image 22 generated based on that evaluation management data and whose position is determined by the posture of a person in a scene indicated by the scene data included in that evaluation management data.

As described above, a plurality of objects are respectively associated with check items in the at least one embodiment.

The evaluation criterion data included in the evaluation management data is data representing an evaluation criterion in the evaluation processing executed based on that evaluation management data. Depending on whether that evaluation criterion is satisfied, it is determined whether a check mark or a cross mark is arranged on the evaluation icon 28.

The captured video receiving module 62 receives a captured video obtained by capturing a video of a person who is making a given motion (a golf swing in the above-mentioned example) from the terminal 12 in the at least one embodiment, for example.

The frame image extraction module 64 extracts frame images representing respective scenes from the captured video in the at least one embodiment, for example. The frame image extraction module 64 may identify, for each of a plurality of predefined scenes, a frame image representing that scene from a plurality of frame images included in the captured video by scene detection technology using a machine learning model such as the Transformer. The frame image extraction module 64 may then extract the frame image representing each scene thus identified from the plurality of frame images included in the captured video. In the above-mentioned example, frame images are extracted which respectively represent nine scenes (address, takeaway, halfway back, top of swing, halfway down, pre-impact, impact, halfway follow, and finish).

The object position identification module 66 identifies, in a frame image representing a certain scene (e.g., the scene of interest), a position at which an object whose position is determined by the posture of a person in that scene is shown in the at least one embodiment, for example. In a case in which a plurality of check items are associated with that scene, the object position identification module 66 identifies the position at which each of a plurality of objects respectively corresponding to the plurality of check items associated with that scene is shown. An example of the object whose position is determined by the posture of a person is a body part of the person. The object position identification module 66 may acquire the frame image extracted by the frame image extraction module 64 and representing the scene determined by the scene determination module 74 described later and may identify, in the acquired frame image, the position at which each of a plurality of objects whose positions are determined by the posture of a person captured in the determined scene and which respectively correspond to the plurality of check items associated with the determined scene is shown.

For example, the object position identification module 66 may identify the position at which the skeleton of a person captured in a frame image is shown in that frame image by using skeletal analysis technology (e.g., OpenPose) using a machine learning model or the like. By applying skeletal analysis technology to a video, the position at which the skeleton is shown in each frame image may be identified. Alternatively, by applying skeletal analysis technology to a still image (frame image), the position at which the skeleton is shown in that frame image may be identified.

Then, the position at which an object (part) that is a part of the skeleton whose position in the frame image is thus identified, the position being determined by the posture of a person, is shown may be identified.

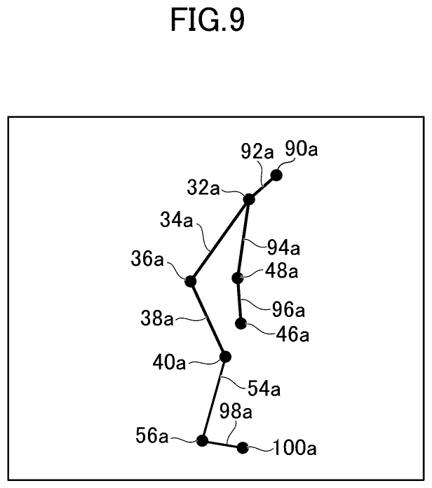

FIG. 9 is a diagram for illustrating an example of a skeleton whose position in a frame image representing the scene of address is identified by applying skeletal analysis technology to the frame image. In the example of FIG. 9, the positions of the neck 32a, the back 34a, the hip 36a, the right thigh 38a, the right knee 40a, the right calf 54a, the right ankle 56a, a head 90a, a back of neck 92a, a right upper arm 94a, a right elbow 48a, a right lower arm 96a, a right hand 46a, a right foot 98a, and a right toe 100a in the scene of address are illustrated. In the identified display images 22 illustrated in FIG. 2, FIG. 3, and FIG. 5, parts being portions of a skeleton whose positions in a frame image are illustrated in FIG. 9 are displayed to be identified. In FIG. 4 and FIG. 6, the upper side 42 passing through a part (e.g., the neck 32a) that is a portion of the skeleton whose position in the frame image is illustrated in FIG. 9 is displayed to be identified. The body parts included in the skeleton illustrated in FIG. 9 are merely an example. The position of a part other than those parts may be identified, or the position of at least some of those parts may not be identified.

Similarly, by applying skeletal analysis technology to a frame image representing the scene of top of swing, the position of the skeleton of a person in that frame image may be identified. In the identified display images 22 illustrated in FIG. 3, FIG. 4, and FIG. 5, parts being portions of the skeleton whose position is thus identified are displayed to be identified. For example, the neck 32b, the back 34b, the hip 36b, the right thigh 38b, the right knee 40b, the right hand 46b, the right elbow 48b, the left hand 50b, the left elbow 52b, the right calf 54b, and the right ankle 56b correspond to portions of the skeleton whose positions in the frame image representing the scene of top of swing are identified.

The object position identification module 66 may identify the position at which an object moving together with the motion of the person and possessed or used by the person is shown in a frame image by applying object recognition technology. For example, the object position identification module 66 may identify the position at which a golf club is shown (the position at which a clubhead is shown and the position at which a club shaft is shown) in a frame image. In FIG. 4 and FIG. 6, the lower side 44 being a line along the club shaft whose position is identified in the frame image representing the scene of address is illustrated. In addition, in FIG. 6, a clubhead 58b whose position is identified in the frame image representing the scene of top of swing is illustrated. The identified display image generation module 68 generates the identified display image 22 that is a frame image in which the position identified by the object position identification module 66 is displayed to be identified in the at least one embodiment, for example. The identified display image generation module 68 may generate the identified display image 22 based on evaluation management data. For example, the identified display image generation module 68 may generate the identified display image 22 in which the position of an object indicated by reference object data included in evaluation management data in a frame image representing a scene indicated by scene data included in that evaluation management data and the position of an object indicated by comparison target object data included in that evaluation management data in that frame image are displayed to be identified. The identified display image generation module 68 may generate a plurality of identified display images 22 respectively associated with a plurality of pieces of evaluation management data.

For example, based on evaluation management data with an ID 001, the identified display image 22 (see FIG. 2) may be generated in which the positions of the neck 32a, the back 34a, the hip 36a, the right thigh 38a, and the right knee 40a in the frame image representing the scene of address are displayed to be identified.

Further, the frame image extraction module 64 may extract a first frame image representing a first scene (e.g., the scene of address) from the captured video in the at least one embodiment. The frame image extraction module 64 may then extract a second frame image representing a second scene (e.g., the scene of top of swing) later than the first scene from the captured video.

The object position identification module 66 may then identify the position at which a first object whose position is determined by the posture of a person in the first scene is shown in the first frame image. The object position identification module 66 may then identify the position at which a second object whose position is determined by the posture of a person in the second scene is shown in the second frame image.

The identified display image generation module 68 may generate the identified display image 22 being the second frame image in which the position in the second frame image, corresponding to the position at which the first object is shown in the first frame image, and the position at which the second object is shown in the second frame image are displayed to be identified.

The reference object described above corresponds to an example of the first object, and the comparison target object described above corresponds to an example of the second object. The first object and the second object may be displayed to be identified in different forms (e.g., in different colors or shapes). For example, the first object may be represented with a broken line, and the second object may be represented with a solid line, as illustrated in FIG. 3 and FIG. 5.

For example, the identified display image 22 illustrated in FIG. 3 may be generated based on evaluation management data with an ID 041. Here, the positions at which a neck, a back, and a hip are shown in the frame image representing the scene of address may be identified, for example. Then, the positions in the frame image representing the scene of top of swing, which correspond to the positions of those parts in the frame image representing the scene of address, may be identified (see the neck 32a, the back 34a, and the hip 36a in FIG. 3). Here, the positions in the frame image representing the scene of top of swing, which have the same coordinates as those of the positions in the frame image representing the scene of address, may be identified, for example. Then, the positions at which the neck, the back, and the hip are shown in the frame image representing the scene of top of swing may be identified (see the neck 32b, the back 34b, and the hip 36b in FIG. 3). Then, the identified display image 22 illustrated in FIG. 3 in which those positions are shown may be generated.

Further, the identified display image 22 illustrated in FIG. 4 may be generated based on evaluation management data with an ID 042. Here, the position at which a club shaft is shown in the frame image representing the scene of address may be identified, for example. Then, the position in the frame image representing the scene of top of swing, which corresponds to this position in the frame image representing the scene of address, may be identified (see the lower side 44 in FIG. 4). Further, the position of a line connecting the player's neck 32a and a golf ball to each other may be identified in the frame image representing the scene of address. Then, the position in the frame image representing the scene of top of swing, which corresponds to this position in the frame image representing the scene of address, may be identified (see the upper side 42 in FIG. 4). Then, the positions at which the right hand, the right elbow, the left hand, and the left elbow are shown in the frame image representing the scene of top of swing may be identified (see the right hand 46b, the right elbow 48b, the left hand 50b, and the left elbow 52b in FIG. 4). Then, the identified display image 22 illustrated in FIG. 4 in which those positions are shown may be generated.

Further, the identified display image 22 illustrated in FIG. 5 may be generated based on evaluation management data with an ID 044. Here, the positions at which a hip, a right thigh, a right knee, a right calf, and a right ankle are shown may be identified in the frame image representing the scene of address, for example. Then, the positions in the frame image representing the scene of top of swing, which correspond to the positions of those parts in the frame image representing the scene of address, may be identified (see the hip 36a, the right thigh 38a, the right knee 40a, the right calf 54a, and the right ankle 56a in FIG. 5). Then, the positions at which the hip, the right thigh, the right knee, the right calf, and the right ankle are shown in the frame image representing the scene of top of swing may be identified (see the hip 36b, the right thigh 38b, the right knee 40b, the right calf 54b, and the right ankle 56b in FIG. 5). Then, the identified display image 22 illustrated in FIG. 5 in which those positions are shown may be generated.

Further, the identified display image 22 illustrated in FIG. 6 may be generated based on evaluation management data with an ID 045. Here, the positions of the upper side 42 and the lower side 44 in FIG. 6 may be identified in a similar manner to that in the identified display image 22 illustrated in FIG. 4, for example. Then, the position at which a clubhead is shown may be identified in the frame image representing the scene of top of swing (see the clubhead 58b in FIG. 6). Then, the identified display image 22 illustrated in FIG. 6 in which those positions are shown may be generated.

As illustrated in FIG. 3 and FIG. 5, the first object described above and the second object described above may be the same body part included in a person.

Alternatively, as illustrated in FIG. 4 and FIG. 6, the first object described above and the second object described above may be objects different from each other. In this case, the second object may be a body part included in a person. The second object may be at least a portion of a golf club used by a person.

The evaluation processing execution module 70 executes, for an extracted frame image, evaluation processing associated with a scene represented by that frame image to evaluate the posture of a person captured in that frame image in the at least one embodiment, for example. In the at least one embodiment, different pieces of evaluation processing may be associated with a plurality of scenes, respectively. For each of the plurality of scenes, the evaluation processing associated therewith may be executed.

The evaluation processing execution module 70 may evaluate the posture of a person captured in a frame image, for example, in accordance with an evaluation criterion indicated by evaluation criterion data included in the evaluation management data. In addition, the evaluation processing execution module 70 may evaluate, in a frame image representing a certain scene, the posture of a person captured in the frame image based on the position at which an object whose position is determined by the posture of the person in that scene is shown.

In addition, the evaluation processing execution module 70 may evaluate, based on the position at which the first object is shown in the first frame image representing the first scene and the position at which the second object is shown in the second frame image representing the second scene, the posture of a person in the second scene.

For example, a forward tilt angle of a person captured in the frame image representing the scene of address may be evaluated based on the evaluation management data with an ID 001 and the identified display image 22 illustrated in FIG. 2. For example, in a case in which an angle between the back 34a and the right thigh 38a in the identified display image 22 illustrated in FIG. 2 is 135 degrees or more and 150 degrees or less, the forward tilt angle in the scene of address may be determined as satisfying the evaluation criterion. Otherwise, the forward tilt angle in the scene of address may be determined as not satisfying the evaluation criterion.

Further, for example, a forward tilt angle of a person captured in the frame image representing the scene of top of swing may be evaluated based on the evaluation management data with an ID 041 and the identified display image 22 illustrated in FIG. 3. For example, in a case in which a difference between an angle between the back 34a and a given reference line (e.g., a horizontal line) in the scene of address and an angle between the back 34b and that reference line (e.g., the horizontal line) in the scene of top of swing in the identified display image 22 illustrated in FIG. 3 is 10 degrees or less, the forward tilt angle of a person captured in the frame image representing the scene of top of swing may be determined as satisfying the evaluation criterion. Otherwise, the forward tilt angle of the person captured in the frame image representing the scene of top of swing may be determined as not satisfying the evaluation criterion. As described above, even when the check item is the same (e.g., forward tilt angle), the evaluation criterion may be different between scenes.

Further, for example, elbow and hand positions of a person captured in the frame image representing the scene of top of swing may be evaluated based on the evaluation management data with an ID 042 and the identified display image 22 illustrated in FIG. 4. For example, in a case in which all the positions of the right hand 46b, the right elbow 48b, the left hand 50b, and the left elbow 52b in the scene of top of swing are within a V-zone (i.e., within a region sandwiched by the upper side 42 and the lower side 44) in the identified display image 22 illustrated in FIG. 4, the elbow and hand positions of a person captured in the frame image representing the scene of top of swing may be determined as satisfying the evaluation criterion. Otherwise, the elbow and hand positions of the person captured in the frame image representing the scene of top of swing may be determined as not satisfying the evaluation criterion.

Further, for example, a right knee angle of a person captured in the frame image representing the scene of top of swing may be evaluated based on the evaluation management data with an ID 044 and the identified display image 22 illustrated in FIG. 5. For example, in a case in which a difference between an angle between the right thigh 38a and the right calf 54a in the scene of address and an angle between the right thigh 38b and the right calf 54b in the scene of top of swing is 10 degrees or less in the identified display image 22 illustrated in FIG. 5, the right knee angle of a person captured in the frame image representing the scene of top of swing may be determined as satisfying the evaluation criterion. Otherwise, the right knee angle of the person captured in the frame image representing the scene of top of swing may be determined as not satisfying the evaluation criterion.

Further, for example, a clubhead position captured in the frame image representing the scene of top of swing may be evaluated based on the evaluation management data with an ID 045 and the identified display image 22 illustrated in FIG. 6. For example, in a case in which the position of the clubhead 58b in the scene of top of swing is within a V-zone (i.e., within a region sandwiched by the upper side 42 and the lower side 44) in the identified display image 22 illustrated in FIG. 6, the position of the clubhead captured in the frame image representing the scene of top of swing may be determined as satisfying the evaluation criterion. Otherwise, the position of the clubhead captured in the frame image representing the scene of top of swing may be determined as not satisfying the evaluation criterion. As described above, the posture of a person captured in a frame image may be evaluated based on an object other than the body part of the person.

As described above, the evaluation processing may be associated with a combination of a scene and any one of at least one check item associated with the scene. The evaluation processing execution module 70 may execute, for an extracted frame image, evaluation processing associated with the combination of the scene represented by that frame image and the check item of interest to evaluate the posture of a person captured in that frame image.

The selected scene data receiving module 72 receives selected scene data indicating a scene selected in the terminal 12 from the terminal 12 in the at least one embodiment, for example. For example, when a user performs a predetermined operation such as a tap operation for any one of the scene icons 24 arranged on the analysis result screen 20, the terminal 12 transmits selected scene data including the identifier of the scene corresponding to the scene icon 24 for which the tap operation has been performed to the server 10. The selected scene data receiving module 72 then receives the selected scene data.

The scene determination module 74 determines any one of a plurality of predefined scenes in the at least one embodiment, for example. The thus determined scene corresponds to the scene of interest described above. Here, a predetermined scene (e.g., the scene of address) may be determined as the scene of interest, for example. Alternatively, the scene indicated by the selected scene data received by the selected scene data receiving module 72 may be determined as the scene of interest. The scene determination module 74 may hold the identifier of the scene of interest.

The selected check item data receiving module 76 receives selected check item data indicating a check item selected in the terminal 12 from the terminal 12 in the at least one embodiment, for example. For example, when the user performs a predetermined operation such as a tap operation for any one of the check item icons 26 arranged on the analysis result screen 20, the terminal 12 transmits selected check item data including the identifier of the check item corresponding to the check item icon 26 for which the tap operation has been performed to the server 10. The selected check item data receiving module 76 then receives the selected check item data.

The check item determination module 78 determines any one of at least one check item associated with the scene of interest in the at least one embodiment, for example. The thus determined check item corresponds to the check item of interest described above. Here, a predetermined check item (e.g., forward tilt angle) may be determined as the check item of interest, for example. Alternatively, the check item indicated by the selected check item data received by the selected check item data receiving module 76 may be determined as the check item of interest. The check item determination module 78 may hold the identifier of the check item of interest.

The evaluation result information generation module 80 generates evaluation result information indicating a result of evaluation by the evaluation processing execution module 70 in the at least one embodiment, for example. Here, the analysis result screen 20 may be generated as the evaluation result information, for example.

In the at least one embodiment, the generated evaluation result information is associated with evaluation management data. For example, on the analysis result screen 20 associated with evaluation management data, the scene icon 24 corresponding to the scene indicated by the scene data included in that evaluation management data is displayed to be identified. Further, on the analysis result screen 20 associated with evaluation management data, the check item icon 26 corresponding to the check item indicated by the check item data included in that evaluation management data is displayed to be identified. Further, on the analysis result screen 20 associated with evaluation management data, the identified display image 22 generated based on that evaluation management data is arranged. In addition, on the analysis result screen 20 associated with evaluation management data, the evaluation icon 28 which indicates the evaluation result (e.g., whether the evaluation criterion is satisfied) as to at least one check item associated with the scene indicated by the scene data included in that evaluation management data is arranged.

The evaluation result information transmission module 82 transmits evaluation result information generated by the evaluation result information generation module 80 to the terminal 12 in the at least one embodiment, for example. Here, the evaluation result information transmission module 82 may transmit the analysis result screen 20 associated with the evaluation management data including the scene data indicating the scene of interest and the check item data indicating the check item of interest to the terminal 12, for example. Then, the analysis result screen 20 thus transmitted to the terminal 12 may be displayed on a touch panel (display) of the terminal 12.

The evaluation result information transmission module 82 displays the identified display image 22 that is a frame image in which the position of an object corresponding to any one of a plurality of check items associated with the scene of interest is displayed to be identified, on the display of the terminal 12 as described above in the at least one embodiment, for example.

Further, in response to reception of a check item change request as described above, the evaluation result information transmission module 82 changes the identified display image 22 displayed on the display of the terminal 12 from a frame image in which the position of an object corresponding to any one of check items is displayed to be identified to a frame image in which the position of an object corresponding to a check item different from that check item is displayed to be identified in the at least one embodiment, for example. Here, reception of the selected check item data described above corresponds to an example of the reception of the check item change request, for example.

For example, it is assumed that a predetermined operation is performed for the check item icon 26db while the analysis result screen 20 illustrated in FIG. 3 is displayed. Then, the identified display image 22 arranged on the displayed analysis result screen 20 is changed from the frame image representing the scene of top of swing, in which the positions of objects (a neck, a back, and a hip) corresponding to the check item “forward tilt angle” are displayed to be identified, to the frame image representing the scene of top of swing, in which the positions of objects (a right hand, a right elbow, a left hand, a left elbow, and a V-zone) corresponding to the check item “elbow and hand positions” are displayed to be identified (see FIG. 4).

Further, for example, it is assumed that a predetermined operation is performed for the check item icon 26dd while the analysis result screen 20 illustrated in FIG. 3 is displayed. Then, the identified display image 22 arranged on the displayed analysis result screen 20 is changed from the frame image representing the scene of top of swing, in which the positions of objects (a neck, a back, and a hip) corresponding to the check item “forward tilt angle” are displayed to be identified, to the frame image representing the scene of top of swing, in which the positions of objects (a hip, a right thigh, a right knee, a right calf, and a right ankle) corresponding to the check item “right knee angle” are displayed to be identified (see FIG. 5).

Further, for example, it is assumed that a predetermined operation is performed for the check item icon 26de while the analysis result screen 20 illustrated in FIG. 3 is displayed. Then, the identified display image 22 arranged on the displayed analysis result screen 20 is changed from the frame image representing the scene of top of swing, in which the positions of objects (a neck, a back, and a hip) corresponding to the check item “forward tilt angle” are displayed to be identified, to the frame image representing the scene of top of swing, in which the positions of objects (a clubhead and a V-zone) corresponding to the check item “head position” are displayed to be identified (see FIG. 6).

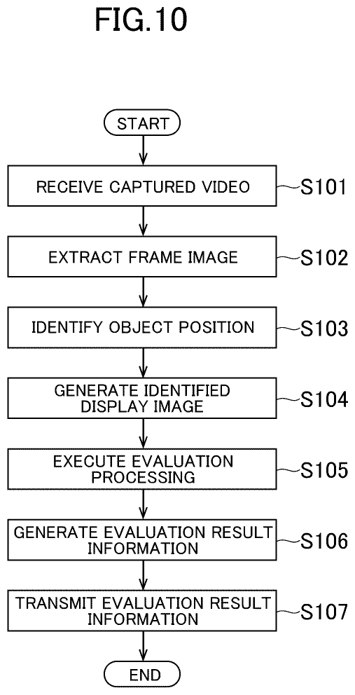

A flow example of processing performed in the server 10 in the at least one embodiment when a captured video is generated in the terminal 12 is now described with reference to a flowchart illustrated as an example in FIG. 10.

First, when a captured video is transmitted from the terminal 12 to the server 10, the captured video receiving module 62 receives the captured video (Step S101).

The frame image extraction module 64 then executes scene detection for the captured video received in the processing step of Step S101 to extract, for each of a plurality of predefined scenes, a frame image representing that scene from a plurality of frame images included in the captured video (Step S102). Nine frame images are extracted here, for example.

For each of the nine frame images extracted in the processing step of Step S102, the object position identification module 66 identifies the position of an object (for example, the reference object and the comparison target object described above) associated with that frame image in that frame image (Step S103).

The identified display image generation module 68 then generates, for each of a plurality of pieces of evaluation management data stored in the evaluation management data storage module 60, the identified display image 22 associated with that piece of evaluation management data (Step S104).

The evaluation processing execution: module 70 then executes, for each of the plurality of pieces of evaluation management data stored in the evaluation management data storage module 60, evaluation processing associated with that piece of evaluation management data (Step S105).

Then, for each of the plurality of pieces of evaluation management data stored in the evaluation management data storage module 60, the evaluation result information generation module 80 generates evaluation result information showing an evaluation result in the evaluation processing of Step S105 (Step S106). Here, for each of the plurality of pieces of evaluation management data stored in the evaluation management data storage module 60, the analysis result screen 20 associated with that piece of evaluation management data may be generated.

The evaluation result information transmission module 82 then transmits any one of the pieces of evaluation result information generated in the processing step of Step S106 to the terminal 12 (Step S107), and the processing described in this processing example is ended. The evaluation result information transmitted in the processing step of Step S107 is displayed on a display, such as a touch panel, of the terminal 12. It is assumed here that the scene of interest in an initial state is the scene of address and the check item of interest in the initial state is a forward tilt angle. In this case, in the processing step of Step S107, evaluation result information associated with the evaluation management data with an ID 001 is transmitted, for example.

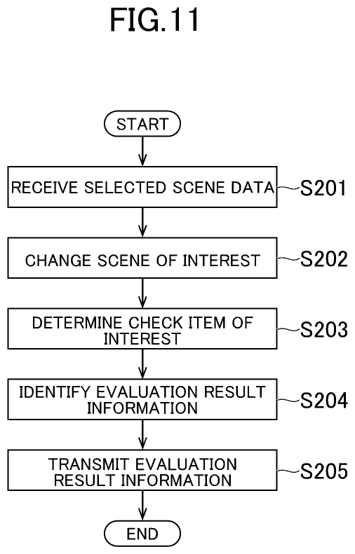

Next, a flow example of processing performed in the server 10 in the at least one embodiment when a user performs a predetermined operation such as a tap operation for any one of the scene icons 24 arranged on the analysis result screen 20 is described with reference to a flowchart illustrated as an example in FIG. 11.

When the predetermined operation is performed for the scene icon 24, and selected scene data including the identifier of the scene corresponding to that scene icon 24 is transmitted from the terminal 12 to the server 10, the selected scene data receiving module 72 receives the selected scene data (Step S201).

The scene determination module 74 then changes the scene of interest to the scene indicated by the selected scene data received in the processing step of Step S201 (Step S202). In this step, the identifier of the scene held by the scene determination module 74 may be updated to the identifier of the scene indicated by the selected scene data received in the processing step of Step S201.

The check item determination module 78 then determines, as the check item of interest, any one of at least one check item associated with the scene indicated by the selected scene data received in the processing step of Step S201 (Step S203). In this case, for example, a predetermined check item may be determined as the check item of interest. The identifier of the check item held by the check item determination module 78 may be updated to the identifier of the changed check item.

The evaluation result information transmission module 82 then identifies, in the pieces of evaluation result information generated in the processing step of Step S106, a piece of evaluation result information associated with evaluation management data including scene data indicating the scene of interest and check item data indicating the check item of interest (Step S204).

The evaluation result information transmission module 82 then transmits the evaluation result information identified in the processing step of Step S204 to the terminal 12 (Step S205), and the processing described in this processing example is ended. The evaluation result information transmitted in the processing step of Step S205 is displayed on a display, such as a touch panel, of the terminal 12. The evaluation result information displayed on the display of the terminal 12 is changed in this manner.

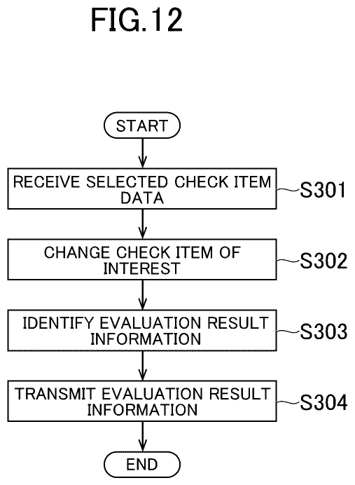

Next, a flow example of processing performed in the server 10 in the at least one embodiment when a user performs a predetermined operation such as a tap operation for any one of the check item icons 26 arranged on the analysis result screen 20 is described with reference to a flowchart illustrated as an example in FIG. 12.

When the predetermined operation is performed for the check item icon 26, and selected check item data including the identifier of the check item corresponding to that check item icon 26 is transmitted from the terminal 12 to the server 10, the selected check item data receiving module 76 receives the selected check item data (Step S301).

The check item determination module 78 then changes the check item of interest to the check item indicated by the selected check item data received in the processing step of Step S301 (Step S302). In this step, the identifier of the check item held by the check item determination module 78 may be updated to the identifier of the check item indicated by the selected check item data received in the processing step of Step S301.

The evaluation result information transmission module 82 then identifies, in the pieces of evaluation result information generated in the processing step of Step S106, a piece of evaluation result information associated with evaluation management data including scene data indicating the scene of interest and check item data indicating the check item of interest (Step S303).

The evaluation result information transmission module 82 then transmits the evaluation result information identified in the processing step of Step S303 to the terminal 12 (Step S304), and the processing described in this processing example is ended. The evaluation result information transmitted in the processing step of Step S304 is displayed on a display, such as a touch panel, of the terminal 12. The evaluation result information displayed on the display of the terminal 12 is changed in this manner.

In the at least one embodiment, it is not required that the server 10 generate evaluation result information associated with every piece of evaluation management data stored in the evaluation management data storage module 60 in response to reception of a captured video as in the processing example illustrated in FIG. 10.

For example, a frame image of the scene of interest in the initial state may be extracted in the processing step of Step S102. Then, the position of an object of at least one check item associated with that scene of interest in that frame image may be identified in the processing step of Step S103. Then, the identified display image 22 associated with the combination of that scene of interest and the check item of interest in the initial state may be generated in the processing step of Step S104. Then, for each of at least one check item associated with that scene of interest, the evaluation processing associated with the combination of that scene of interest and that check item may be executed in the processing step of Step S105. Then, the evaluation result information associated with that scene of interest and that check item of interest may be generated in the processing step of Step S106.

Every time the scene of interest is changed, the processing steps of Step S102 to Step S106 may be executed for the changed scene of interest. Further, every time the check item of interest is changed, the identified display image 22 associated with the changed check item of interest may be generated.

In the at least one embodiment, the identified display image 22 that is a frame image in which the position of an object corresponding to any one of a plurality of check items associated with a scene is displayed to be identified is displayed on the display of the terminal 12, as described above. Then, in response to reception of a check item change request, the identified display image 22 displayed on the display of the terminal 12 is changed from the frame image in which the position of the object corresponding to any check item is displayed to be identified to a frame image in which the position of an object corresponding to a check item different from that check item is displayed to be identified. Thus, according to the at least one embodiment, it is possible to display how each of a plurality of check items in a scene included in a motion is in an easy-to-understand manner.

Further, in the at least one embodiment, for the posture of a person who is making the motion, it is possible to perform evaluation involving a plurality of scenes included in the motion, for example, a scene of address and a scene of top of swing. Accordingly, according to the at least one embodiment, accurate evaluation can be performed for the posture of the person who is making the motion.

It should be noted that the present invention is not limited to the above-mentioned at least one embodiment.

For example, in response to reception of a scene change request, the evaluation result information transmission module 82 may change the displayed identified display image 22 from a frame image in which the position of an object corresponding to any check item associated with any scene is displayed to be identified and which represents that scene to a frame image in which the position of that object is displayed to be identified and which represents a scene from different that scene. Here, reception of the selected scene data described above corresponds to an example of the reception of the scene change request.

For example, it is assumed that in a situation in which the analysis result screen 20 illustrated in FIG. 3 is displayed, a predetermined operation such as a tap operation is performed for the scene icon 24c. In this case, the analysis result screen 20 on which the identified display image 22 is arranged may be generated, in which the point representing the position of the neck 32a of the player 30, the broken line segment representing the position of the back 34a, the point representing the position of the hip 36a in the scene of address are displayed in a superimposed manner and the point representing the position of the neck of the player 30, the broken line segment representing the position of the back, and the point representing the position of the hip in a scene of halfway back are displayed in a superimposed manner. Then, the analysis result screen 20 displayed on the display of the terminal 12 may be changed to the analysis result screen 20 thus generated.

Further, information related to the above-mentioned evaluation processing may be arranged in the identified display image 22, for example. For example, a number representing an angle between the back 34a and the right thigh 38a in the identified display image 22 illustrated in FIG. 2 may be arranged in the identified display image 22 illustrated in FIG. 2. Further, a number representing a difference between an angle between the back 34a and a reference line (e.g., a horizontal line) in the scene of address and an angle between the back 34b and that reference line (e.g., the horizontal line) in the scene of top of swing in the identified display image 22 illustrated in FIG. 3 may be arranged in the identified display image 22 illustrated in FIG. 3. Further, numbers representing an angle between the right thigh 38a and the right calf 54a in the scene of address and an angle between the right thigh 38b and the right calf 54b in the scene of top of swing in the identified display image 22 illustrated in FIG. 5 may be arranged in the identified display image 22 illustrated in FIG. 5. Further, a number representing a difference between an angle between the right thigh 38a and the right calf 54a in the scene of address and an angle between the right thigh 38b and the right calf 54b in the scene of top of swing in the identified display image 22 illustrated in FIG. 5 may be arranged in the identified display image 22 illustrated in FIG. 5.

Also for a scene other than the scene of address and the scene of top of swing, the analysis result screens 20 similar to the analysis result screens 20 illustrated in FIG. 2 to FIG. 6 may be displayed.

The application range of the present invention is not limited to a situation of analyzing a golf swing, and for example, the present invention can be applied to a situation of analyzing a swing or a motion in other sports. The present invention is also applicable to other general motion analysis such as dance.

All or some of the functions illustrated in FIG. 7 may be implemented by the terminal 12.

The specific character strings and numerical values described above and the specific character strings and numerical values in the drawings are merely exemplary, and the present invention is not limited to those character strings and numerical values.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A motion analysis system, comprising:
at least one processor; and
at least one memory device storing instructions which, when executed by the at least one processor, cause the at least one processor to perform operations comprising:
extracting a frame image representing each of a plurality of scenes from a video obtained by capturing a person who is making a given motion;
determining any one of the plurality of scenes;
identifying, in the frame image representing the determined one of the plurality of scenes, a position at which each of a plurality of objects respectively corresponding to a plurality of check items associated with the determined one of the plurality of scenes is shown, the position of the each of the plurality of objects being determined by a posture of the person in the determined one of the plurality of scenes;
displaying an identified display image, the identified display image being the frame image in which the position of one of the plurality of objects corresponding to any one of a plurality of check items associated with the determined one of the plurality of scenes is displayed to be identified; and
changing, in response to reception of a check item change request, the displayed identified display image from the frame image in which the position of the one of the plurality of objects corresponding to the one of the plurality of check items is displayed to be identified to the frame image in which the position of one of the plurality of objects corresponding to a check item different from the one of the plurality of check items is displayed to be identified.

2. The motion analysis system according to claim 1, wherein the changing includes changing, in response to reception of a scene change request, the displayed identified display image from the frame image representing any one of the plurality of scenes, in which the position of one of the plurality of objects corresponding to any one of the plurality of check items associated with the one of the plurality of scenes is displayed to be identified, to the frame image representing one of the plurality of scenes different from the one of the plurality of scenes, in which the position of the one of the plurality of objects is displayed to be identified.

3. The motion analysis system according to claim 1, wherein at least one of the plurality of objects is a body part included in the person.

4. The motion analysis system according to claim 3,
wherein the operations further comprise identifying a position at which a skeleton of the person captured in the frame image is shown in the frame image, and
wherein at least one of the plurality of objects is a portion of the skeleton.

5. The motion analysis system according to claim 1, wherein at least one of the plurality of objects is at least a portion of a golf club used by the person.

6. A motion analysis method, comprising:
determining any one of a plurality of scenes;
acquiring a frame image representing the determined one of the plurality of scenes, the frame image being one of frame images respectively representing the plurality of scenes and extracted from a video obtained by capturing a person who is making a given motion;
identifying, in the acquired frame image, a position at which each of a plurality of objects which have the positions determined by a posture of the person in the determined one of the plurality of scenes and which respectively correspond to a plurality of check items associated with the determined one of the plurality of scenes is shown;
displaying an identified display image, the identified display image being the frame image in which the position of one of the plurality of objects corresponding to any one of a plurality of check items associated with the determined one of the plurality of scenes is displayed to be identified; and
changing, in response to reception of a check item change request, the displayed identified display image from the frame image in which the position of the one of the plurality of objects corresponding to the one of the plurality of check items is displayed to be identified to the frame image in which the position of one of the plurality of objects corresponding to a check item different from the one of the plurality of check items is displayed to be identified.

7. A non-transitory computer readable information storage medium storing a program that causes a computer to execute:
determining any one of a plurality of scenes;
acquiring a frame image representing the determined one of the plurality of scenes, the frame image being one of frame images respectively representing the plurality of scenes and extracted from a video obtained by capturing a person who is making a given motion;
identifying, in the acquired frame image, a position at which each of a plurality of objects which have the positions determined by a posture of the person in the determined one of the plurality of scenes and which respectively correspond to a plurality of check items associated with the determined one of the plurality of scenes is shown;
displaying an identified display image, the identified display image being the frame image in which the position of one of the plurality of objects corresponding to any one of a plurality of check items associated with the determined one of the plurality of scenes is displayed to be identified; and
changing, in response to reception of a check item change request, the displayed identified display image from the frame image in which the position of the one of the plurality of objects corresponding to the one of the plurality of check items is displayed to be identified to the frame image in which the position of one of the plurality of objects corresponding to a check item different from the one of the plurality of check items is displayed to be identified.
